(19) United States
(12) Patent Application Publication
(10) Pub. No.: US 2011/0022515 A1
(43) Pub. Date: Jan. 27, 2011

(54) Mobile payment system

(75) Inventors: Michael L. Tallitsch, Mosinee, WI (US); Jeremy Martens, Wisconsin Rapids, WI (US); Carl Woodruff, Urbandale, IA (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: Wausau Financial Systems, Inc.

(21) Appl. No.: 12/460,733

(22) Filed: Jul. 23, 2009

(51) Int. Cl. G06Q 20/00

(52) U.S. Cl. 705/40

(57) ABSTRACT

A mobile payment system is disclosed for processing payments authorized by mobile devices (“mobile payments”) that is configured to process mobile payment authorizations that are directed to an electronic lock box. The mobile payment authorizations are processed by way of electronic funds transfer and cleared, for example, by way of an automated electronic funds clearing network, such as the Automated Clearing House (ACH). In accordance with an important aspect of the invention, the mobile payment system also processes returns for payments that cannot be cleared. The mobile payment system may be configured to provide advance notification of billing deadlines to payees, e.g., mobile clients, by way of an SMS (Small Message System) message and enable consumers to authorize payment in the same fashion. In addition to facilitating payment by the consumer, the system in accordance with the present invention significantly the “float time” and makes funds available to the merchant in a relatively shorter period of time than known mobile payment systems, once payment authorization is received from the consumer.

### COMPUTER APPENDIX

This application includes a Computer Listing Appendix on compact disc, hereby incorporated by reference.

### BACKGROUND OF THE INVENTION

1. Field of the Invention

The present invention relates to a “green payment system” for processing payments authorized by mobile devices (“mobile payments”) that is configured to process mobile payment authorizations sent to an electronic lock box in which mobile payment authorizations are received, processed and cleared or alternatively processes returns for payments that cannot be cleared.

2. Description of the Prior Art

Electronic payment systems for bill payment are well known in the art. Such electronic payment systems reduce the cost of payment processing for all involved. In particular, by eliminating the need for paper and check processing the banks' as well as the creditors'/merchants' costs are significantly reduced. Electronic payment processing is also beneficial to the consumer by eliminating the need for stamps and trips to the U.S. Post Office to mail the payment.

Various electronic payment processing systems are known. These systems differ by the type of authorization provided by the consumer and to whom the authorization is provided. For example, periodic authorizations are known in which a consumer provides an authorization to a merchant or other creditor to periodically request funds from the consumer's account by providing the creditor or merchant with a voided check. With such authorizations, the merchant/creditor can simply make an electronic presentment to the bank for payment on a periodic basis, in which case the bank will pay the merchant/creditor automatically on a periodic basis with no further action from the consumer. In other applications, the consumer can authorize a single non-periodic payment. In this application, a single payment by electronic funds transfer is made to the merchant/creditor and debited to the consumer's bank account.

The various electronic payment systems utilize various known ways of access. For example, web portals are known. With such web portals, bank consumers normally authorize electronic fund transfers for bill payments by way of the bank's web page. In such applications, the consumer logs into the bank's web portal and decides which bills to pay electronically and then authorizes the bank to make those payments.

Other types of access to electronic payment systems utilize mobile devices, such as cell phones and personal digital assistants (PDAs). This type of electronic payment system is hereinafter referred to as a “mobile payment system”. Such mobile payment systems are known to be configured for access by mobile devices that are Internet enabled mobile devices as well as mobile devices which are not Internet enabled. Examples of such mobile payment systems include: U.S. Patent Application Publication Nos. US 2009/0037294 A1; US 2008/0319905 A1; US 2008/0275779 A1; US 2008/0189186 A1; US 2008/0167017 A1; US 2008/0172317 A1 and US 2008/0162318 A1, all hereby incorporated by reference.

Such known mobile payment systems are also known to provide payment notifications. For example, U.S. Patent Application Publication No. 2004/0078327 A1 discloses a mobile payment notification system. In this system, notification of bill deadlines is sent to wireless clients along with a notification of locations for in-person bill payments.

There are various problems associated with known mobile payment systems. In particular, the amount of time it takes for payment to be credited to the merchant's account after a mobile payment is authorized by a consumer can be relatively long. For example, with some known mobile payment systems, it can take, for example, 20 days or more after a payment is authorized by a consumer before the payment is credited to a merchant's bank account. The reason for the delay is that known mobile payment systems are configured so that mobile payment transactions are communicated between a consumer and the consumer's bank. Once a payment is authorized by the consumer, the consumer's bank electronically presents the payment authorization to the merchant's bank for payment. The merchant bank then clears the electronic payment, for example, by way of an Automatic Clearing House (ACH). After an electronic payment is cleared, the merchant's bank account is credited with the amount of the electronic payment. Inasmuch as a single merchant will typically have consumer accounts with consumers who utilize a multitude of different banks, processing of consumer accounts can take a substantial amount of time, thus delaying crediting of the payments to the merchant's bank account, for example, for up to 20 days or more.

Alternatively, bill payments to merchants are made by paper check. Payments made by check are normally handled in a totally different manner than mobile payments. In particular, in order to facilitate processing of paper checks, automatic remittance processing systems have been developed to automatically process such payments. Examples of such remittance processing systems are known, such as ImageRPS™ by Wausau Financial Systems, Inc. and others. In such systems, all payments are directed to a merchant's lock box. As used herein, the term “lock box” refers to a common location, such as a P.O. Box, designated by the merchant for receiving payments. Such automatic remittance processing systems include scanners for scanning checks and payment stubs received at the lock box. Once scanned, payments are electronically processed. The processing includes sending the checks to a clearing house for clearing and deposit in the merchant's account as well as providing an accounting of the payments to the merchant.

In such automatic remittance processing systems, checks are mailed by consumers to the Lock Box. The checks are scanned and converted to electronic form. The electronic checks are presented electronically, for example, to an Automated Clearing House (ACH) for clearing and eventually deposited in the merchant's account.

Unfortunately, lock box functionality is not heretofore known for mobile payments. As such, as mentioned above, payments made by known mobile payment systems are not credited to a merchant's account for a relatively long time. Thus, there is a need for a mobile lock box payment system which speeds up processing of payments made by mobile devices and significantly reduces the time from authorization of a payment from a mobile device to crediting of that payment to the merchant's bank account.

### SUMMARY OF THE INVENTION

The present invention relates to a mobile payment system for processing payment authorizations initiated by mobile devices (“mobile payments”). The mobile payment system is configured to receive mobile payment authorizations that are directed to the electronic lock box. The mobile payment system processes such mobile payment authorizations by way of electronic funds transfer and clears them by way of an automated clearing network, such as ACH. In accordance with an important aspect of the invention, the mobile payment system also processes returns for payments that cannot be cleared. In addition to facilitating payment by the consumer, the mobile payment lock box system in accordance with the present invention significantly reduces the “float time” and makes funds available to the merchant in a relatively shorter period of time than known mobile payment systems, once payment authorization is received from the consumer. The mobile payment system in accordance with the present invention provides additional benefits for both the merchants and the consumers as set forth below.

### Benefits for Merchants

Improves receivables, for example, by up to 20 days or more.
Provides a method for expedited payments.
Provides an opportunity for revenue generation from convenience fees to be charged to the consumers.
Provides a two-way communication channel between the merchant and the consumer for cross-sell activity to an attentive audience.
Reduces payment processing costs by reducing paper transactions flowing into the lockbox.
Promotes “green” efforts through elimination of paper transportation, distribution and handling.

### Benefits for Consumers

Enables notification and control of the timing of electronic payments submission.
Enables anytime, anywhere bill payment without credit cards.
Provides a secure and convenient payment system.
Environmentally friendly and saves consumers money and time by eliminating the need to mail remittances.

### DESCRIPTION OF THE DRAWING

These and other advantages of the present invention will be readily understood with reference to the following specification and attached drawing wherein:

FIG. 1 is a block diagram of the mobile payment system in accordance with the present invention.

FIG. 2 is a high level operational process flow diagram of the mobile payment system illustrated in FIG. 1.

FIG. 3 is a high level diagram of the mobile payment return flow of the mobile payment system illustrated in FIG. 1.

FIG. 4 illustrates cell phone display with an exemplary SMS message of a payment notification of a utility bill.

### DETAILED DESCRIPTION

The present invention relates to a mobile payment system for use by merchants for processing electronic payment authorizations authorized by mobile devices (“mobile payments”). In accordance with the present invention, mobile payment authorizations are directed to an electronic lock box. Such payment authorizations processed by way of electronic funds transfer and cleared, for example, by way of the Automated Clearing House (ACH). For payments that cannot be cleared, the mobile payment system automatically processes returns. In addition, the mobile lock box payment system may be optionally configured as a two-way system which can provide advance notification of payment deadlines to consumers, e.g., mobile clients, by way of SMS messages and enable consumers to authorize payment in the same fashion.

As used herein, SMS messages are understood to mean the same as text messages. Moreover, although the system is described and illustrated in terms of SMS messages, the principles of the invention are also applicable to systems which utilize MMS (Multimedia Message Service) messages as well as email message systems.

In accordance with an important aspect of the present invention, the mobile payment system in accordance with the present invention cuts down on the “float time” of the electronic payments and makes funds available to the merchant in a relatively shorter time than known mobile payment systems, once payment authorization is received from the consumer. As used herein, the terms: “mobile devices” and “mobile clients” are intended to include all wireless devices which can communicate over a cellular telephony network, such as cell phones and personal digital assistants. In addition, such mobile devices and mobile clients are also intended to include mobile personal computers, such as laptop computers, which can communicate over a wireless network, such as a satellite network. The term “electronic device” is intended to mean any device that can communicate electronically with a remote device over a wired or wireless communication link.

As mentioned above, the mobile payment process system in accordance with the present invention may optionally be configured to notify consumers of payment deadlines by SMS messages. The timing of the notification messages may be selectable by the merchant. Since most bills are sent out on a monthly basis, the timing may be set from 0 days from the payment deadline to a predetermined number of days before the payment deadline as well as a predetermined number of days after the payment deadline in the so-called grace period.

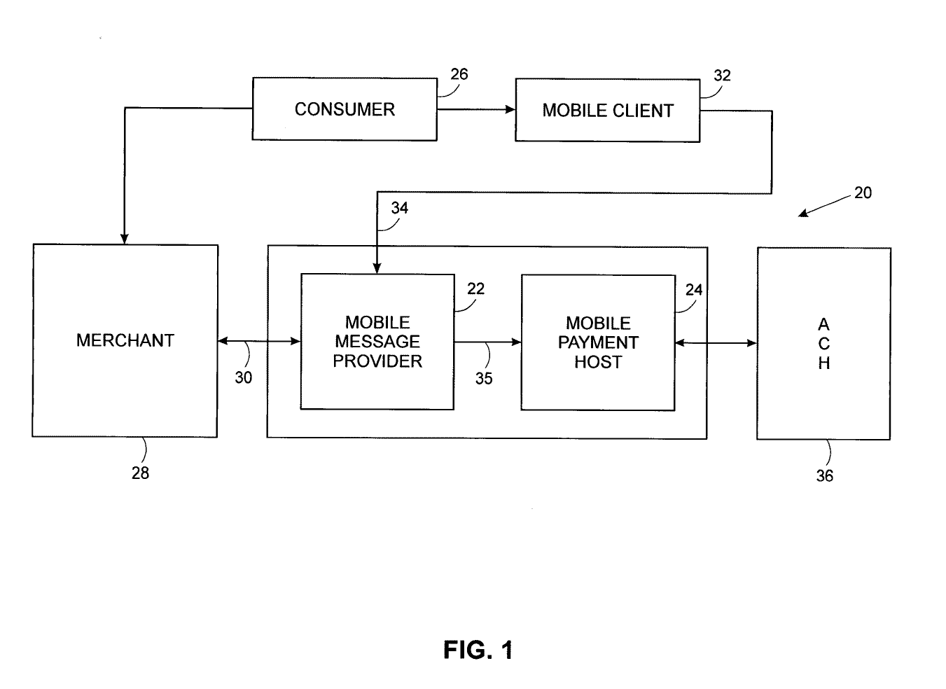

FIG. 1 is block diagram of the mobile payment system in accordance with the present invention. The mobile payment system is generally identified with the reference numeral 20 and includes a mobile message provider 22 and a mobile payment host 24. The mobile message provider 22 is responsible for communicating with the merchants 28, the mobile clients 32 and the mobile payment host 24. As will be discussed in more detail below, notifications of payment deadlines may be received from the merchant 28 by the mobile message provider 22 and converted to SMS messages and sent to the mobile clients 32. Information and responses from the mobile clients 32 are received by the mobile message provider 22 and passed onto the mobile payment host 24 including the consumer's account information and other information as discussed below.

Various systems are suitable for handling the functions of the mobile message provider 22. In particular, various known mobile payment systems are configured to communicate with mobile devices and forward payment authorizations from a mobile device to a bank. For those mobile payment systems that provide payment notification to the consumers, the mobile payment systems are also configured to electronically communicate with the merchant 28. In particular, various mobile payment systems, for example, a mobile banking system available by ClairMail, Inc. and others, are suitable for use with the present invention. U.S. Patent Application Publication No. US 2009/0048926 A1, hereby incorporated by reference, discloses a system for sending and receiving SMS messages to and from mobile devices, such as cell phones and PDAs.

In accordance with the present invention, mobile payment authorizations from mobile clients 32 are directed to a mobile payment host 24, which acts as an electronic lock box. As such, in accordance with the present invention, the mobile message provider 22 is configured to be in communication with the mobile clients 32 and the mobile payment host 24 and a merchant or other creditor 28.

As used herein, a mobile payment authorization is intended to mean a payment authorization that is received from a mobile device and sent to an electronic lock box. The mobile payment system 20 in accordance with the present invention includes a mobile message provider 22 which receives all mobile payment authorizations. The payment authorizations, in turn, are directed to a mobile payment host 24 along with merchant and consumer account data. The mobile payment host 24 acts as an electronic lock box by electronically receiving all of the consumer payment authorizations. Mobile payments are automatically processed by the mobile payment host 24, cleared and deposited in the merchant's account making the funds available to the merchant's account much faster than known mobile banking systems, for example, 21 days faster.

A general description of the operation of the mobile payment system is discussed below. Initially, consumers 26 wishing to utilize the mobile payment system 20 in accordance with the present invention register their mobile client 32 with a merchant 28. For simplicity, only a single merchant 28 is illustrated in FIG. 1. In actuality, a consumer 26 would have to register with each merchant 28 for which mobile payment capability is desired. In addition, only a single mobile client 32 is shown for each consumer 26, although multiple mobile clients 32 per consumer 26 are considered to be within the scope of the invention.

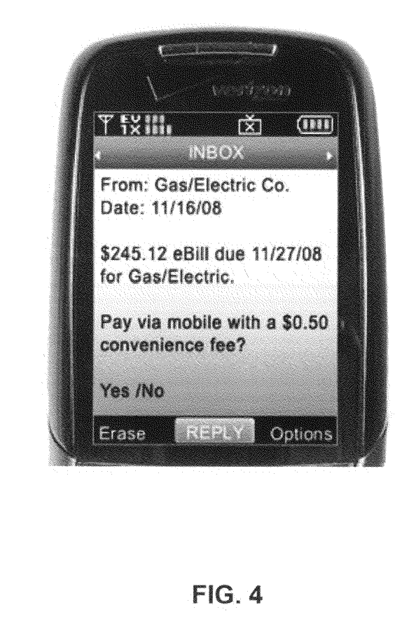

The registration process requires certain information from the consumer 26 including the mobile device telephone number and/or email address and the consumer's account number with the merchant. In addition, the consumer's bank account number and bank routing information, individually and collectively referred to herein as “consumer data” is also provided by the consumer during the registration process. The registration information received by the merchant 28 is stored within the merchant's CIS (Computer Information System) environment and shared with the mobile message provider 22. As will be discussed in more detail below, each merchant 28 for which the consumer 26 is registered may notify the mobile message provider 22 of payment deadlines for the consumer's account by way of a communication link 30 by account number and also provide the consumer's mobile telephone number or IP/email address and the consumer's bank account information. The merchant 28 also provides the mobile message provider 22 with its bank account number and bank routing number, as well as the payment deadline and minimum payment amount for the consumer's account, referred to herein as “merchant data”. Upon receipt of the consumer data and the merchant data from the merchant 28, the mobile message provider 22 automatically composes an SMS message which includes, for example, the name of the merchant, the date the payment is due and the amount due. Vanity or generic names for the merchant may be utilized. For example, a gas/electric utility company may be designated generically, as illustrated in FIG. 4.

An exemplary text message, e.g., an SMS message, is illustrated in FIG. 4. As shown, the SMS message includes a reply button and a selectable response. As shown, the selectable response is illustrated as “Yes/No”. Other selectable responses, such as “Pay/Do Not Pay” are also appropriate. A text message may alternatively be provided without a selectable response. In such an application, the consumer keys in a response, e.g., Pay or Do Not Pay. Other information may be included in the SMS message, such as information regarding convenience fees.

In operation, the mobile payment system 20 enables the merchant 28 to send a payment notification along with the consumer's mobile device phone number (or email address) and bank and merchant account information to the mobile message provider 22 by way of the communication link 30, which may be a wireless link over the Internet or a telephony link over an existing cellular telephone network, for example a G-3 network. The mobile message provider 22 uses this information from the merchant 28 to compose an SMS message (or email), for example, as illustrated in FIG. 4, and send it to the consumer's mobile client 32 by way of a wireless communication network, for example, cellular telephony network 34. The consumer 32 may reply by return SMS message to the mobile message provider 22 over cellular telephony network 34 thereby providing two-way communication between the consumer and the mobile payment system 20. The reply from the consumer 26 may be received by the mobile message provider 22 and passed along with the consumer's merchant account and payment information to the mobile payment host 24 by way of a communication link 35, which may wired or wireless and may be an Internet communications link or a telephony communications link. Although the mobile message provider 22 and the mobile payment host 24 are shown within the box 20, these systems can be in the same or different locations.

The merchant data is initially passed on from the merchant to the mobile message provider 22 and on to the mobile payment host 24 when the merchant initially signs up for mobile payment capability. Once a merchant 28 is signed up for mobile payment processing, electronic payments authorized by consumers 26 are processed and automatically credited to the merchant's account. Specifically, upon authorization of a payment authorization from a mobile client, the consumer data and the merchant data, as defined above, are presented to an automated clearing house for clearing. For example, all mobile payments may be cleared by way of an Automated Clearing House network 36. In the event the clearing house network 36 is unable to clear the funds, the mobile payment system 20 processes the return and notifies the merchant 28, for example, by way of a web portal or other method, as discussed in more detail below.

The mobile payment system 20 in accordance with the present invention can be broken down into four (4) major components: registration, customer notification, payment and returns. The first three components are self-explanatory. The fourth component, returns, refers to payments that cannot be processed for various reasons including insufficient funds, closed account and stop payments. Each of these components is discussed in detail below.

### Registration

In order to take advantage of the mobile payment system 20 in accordance with the present invention, consumers 32 are required to register for this service. In accordance with one aspect of the invention, one or more registration methods may be employed. For example, a consumer 32 may register by way of a web portal; IVR (Interactive Voice Response) System; or by way of a text message. As will be discussed in more detail below, registration completion confirmation by the consumer 26 for example, may be handled by way of an SMS message. All three of the registration methods are discussed below.

Registration by way of the web portal may require three (3) steps. In this type of registration, the consumer 26 signs on to the web portal hosted by the merchant 28. The consumer 26 enters the following information in dialog boxes provided by the merchant on a web page at the web portal IP address: mobile telephone number and “MICR” data, i.e., account number and bank routing number, available on the consumer's check, and opt-in registration information. The opt-in registration information includes the merchant's account number and authentication information. After the various dialog boxes on the web page are completed, the merchant 28 passes the information to the mobile message provider 22, which automatically generates an SMS message and forwards it to the consumer 32 by way of the wireless communication link 34. For security purposes, in order to complete the registration by this method, the consumer 26 must reply by way of the mobile client 32 to the SMS message as confirmation of the registration. The reply SMS message is received by the mobile message provider 22 over the wireless communication link 34. After receiving the confirmation from the mobile client 32, the mobile message provider 22 provides an indication to the merchant 28 that the registration is complete by way of the wireless communication link 30. Once the registration is complete, the merchant 28 can then initiate periodic notifications of payment deadlines by the mobile message provider 22 to the mobile clients 32, as will be discussed in more detail below.

Alternatively, registration can be accomplished by way of an IVR (Interactive Voice Response) system. IVR registration may also consist of a three (3) step process. Initially, a consumer 26 is provided with a telephone number of the IVR system, for example, on a bill or otherwise. In step one, the consumer dials into the IVR system. Once connected to the IVR system, the consumer 26 is prompted to key in by way of the telephone touch pad the following information: the merchant's account number, the consumer's MICR data and authentication information.

Other methods for registration are also contemplated. For example, the merchant can encourage adoption of the mobile payment system 20 by providing registration information on paper payment statements. For example, the merchant can initiate registration by providing information on the paper statement requesting a consumer to send a certain text message to a particular text address. For example, the paper payment statement could state that in order to sign up for mobile payment processing, text the message “Go Green” to 12345. The merchant would then reply by SMS image requesting the consumer to register via the web portal or IVR system, discussed above. Alternatively, the paper payment statement could be modified to request mobile telephone number. The consumer's bank account information could be retrieved from the MICR information on the check returned with the consumer's payment. All such registration methods are contemplated by the present invention.

### Customer Notification

In order to facilitate the process for sending the consumer a payment notification, the merchant's account information is sent to the mobile message provider 22. Each consumer 26 may be identified by the merchant 28 by a unique identification number (ID) or account number and mobile telephone number of the mobile client 32. In an exemplary application, the merchant 28 provides a list of consumers' IDs and mobile telephone numbers that have registered for mobile with the payment information, including the amount due and the due date of the payment along with the merchant payment notification preference, for example, as discussed below. In order to prevent mobile payments by consumers 26 who have already made traditional payments by check, the merchant 28 may optionally send a file of all accounts receivable (A/R) transactions that were paid the previous day and cleared. The mobile message provider 22 may then compare the A/R transactions file with the list of consumer IDs and eliminates those consumer IDs that are listed in the A/R transactions file as having made a payment which cleared. The remaining customer IDs may then be sent payment notifications. In particular, the mobile message provider 22 may compose an SMS message of the payment amount due, the due date for the payment and the name of the merchant and send it to the consumer's mobile phone, for example, as illustrated in FIG. 4.

Delivery of the SMS messages to the consumer 26 can be on a scheduled basis, as well as multiple times during a billing cycle. The frequency and timing of the notifications, i.e., merchant payment notification preferences, may be selectable by the merchant 28. Multiple payment notifications per billing cycle may be selected by the merchant 28. For example, a first payment notification may be submitted to the mobile client 32, 20 days before the payment is due at no cost to the consumer 26. In this case, the free mobile payment transaction is leveraged against the fact that merchant will likely have the funds the next day-19 days earlier than payments received on the due date. As payments are made closer to the due date, transaction fees between, for example, $0.50 and $7.00 can be assessed by the merchant for the convenience of the mobile payment and the loss of the advantage of the early funds.

### Payments

In accordance with the present invention, mobile payments may be made by return SMS message from the consumer's mobile client 32. In particular, a consumer 26 replies to a notification from the mobile message provider 22 in order to authorize payment. As shown in FIG. 4, for example, the consumer 26 simply highlights the “Yes” on the screen and triggers the “REPLY” button. Alternatively, the consumer replies to the notification by texting the word “Yes” or “Pay”. The reply authorizes payment for the amount due to the specified merchant plus any convenience fee. The SMS message from the consumer 26 is received by the mobile message provider 22. The mobile telephone number associated with the SMS message is correlated to a unique consumer ID. The customer ID and the payment amount is passed to the mobile payment host 24, for example, in a batch transaction file for import. Each batch file may relate to a single merchant 28. The mobile payment host 24 imports the batch transaction file and assigns a merchant ID and a batch ID. The mobile payment host 24 may process each batch file by posting payments to the consumer IDs from consumer bank account data and consumer merchant account data, passed along by the mobile message provider 22 for each customer ID. The mobile payment host 24 may create a deposit record for all of the electronic payments posted. All mobile payment transaction batches may be collected at a scheduled cut-off time, e.g., at the end of the each day, and cleared by way of an electronic funds transfer clearing network 36, such as ACH and deposited in the merchant's bank account.

### Returns

In accordance with an important aspect of the invention, the mobile payment system 20 is configured to automatically process electronic payments that cannot be processed, i.e., returns for various reasons including non-sufficient funds (NSF); closed accounts; and stop payment orders. A returns file from the ACH 36 is normally sent to the merchant 28 along with a return reason code, for example, non-sufficient funds (NSF) or other return code. In accordance with the present invention, the Return File is returned from the ACH 36 to the Mobile Payment Host 24 and automatically processed before being sent to the merchant 28. Depending on the return reason code, the return will be automatically evaluated and identified for either automatic or operator assisted processing by the Mobile Payment Host 24.

Administrative returns, for example, due to errors in consumer's bank account or routing information, may be designated for operator assisted processing. In the case of administrative returns, an operator may contact the merchant 28 and/or the consumer 26 to obtain the correct consumer account information. Other returns, such as non-sufficient funds (NSF) returns, are designated for automatic processing for re-presentment to ACH 36. If the electronic payment does not clear after re-presentment, the return is designated as a final return by the mobile payment host 24 and sent to the merchant 28 for further disposition. The returns may be immediately re-presented to the ACH 36 or designated for re-presentment at a later date.

### Operational Process Flow Diagrams

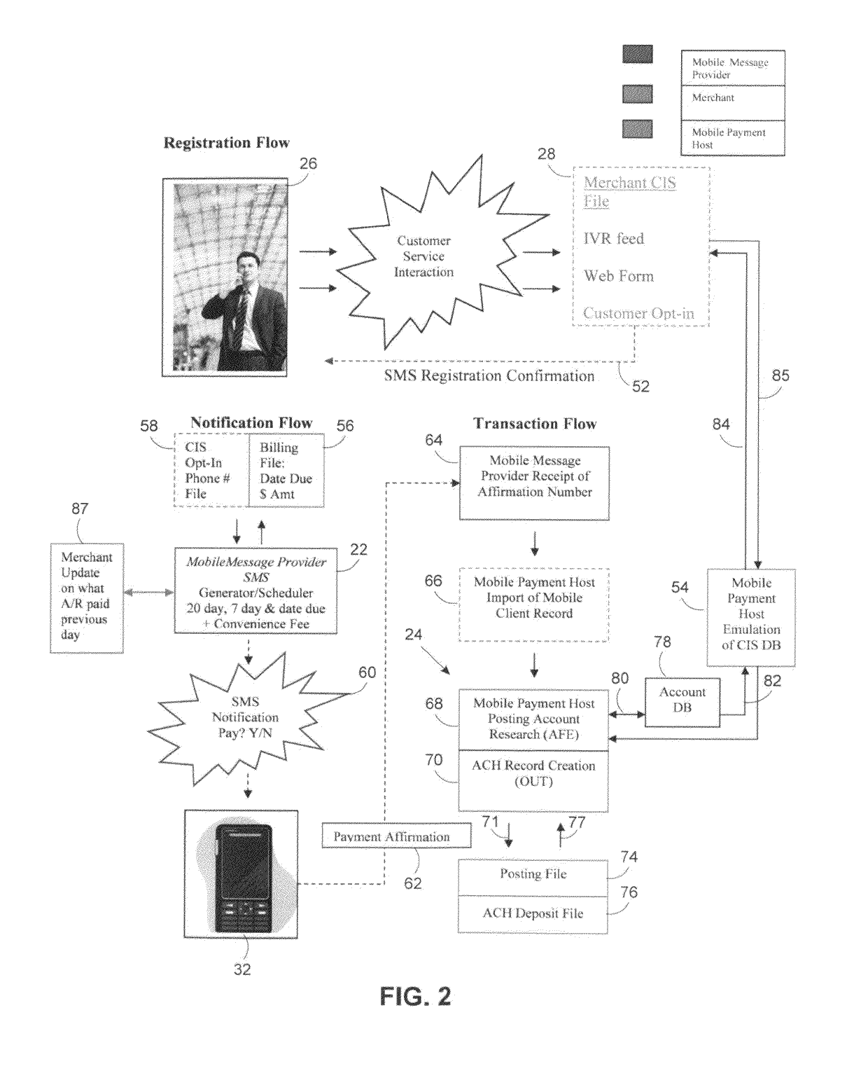

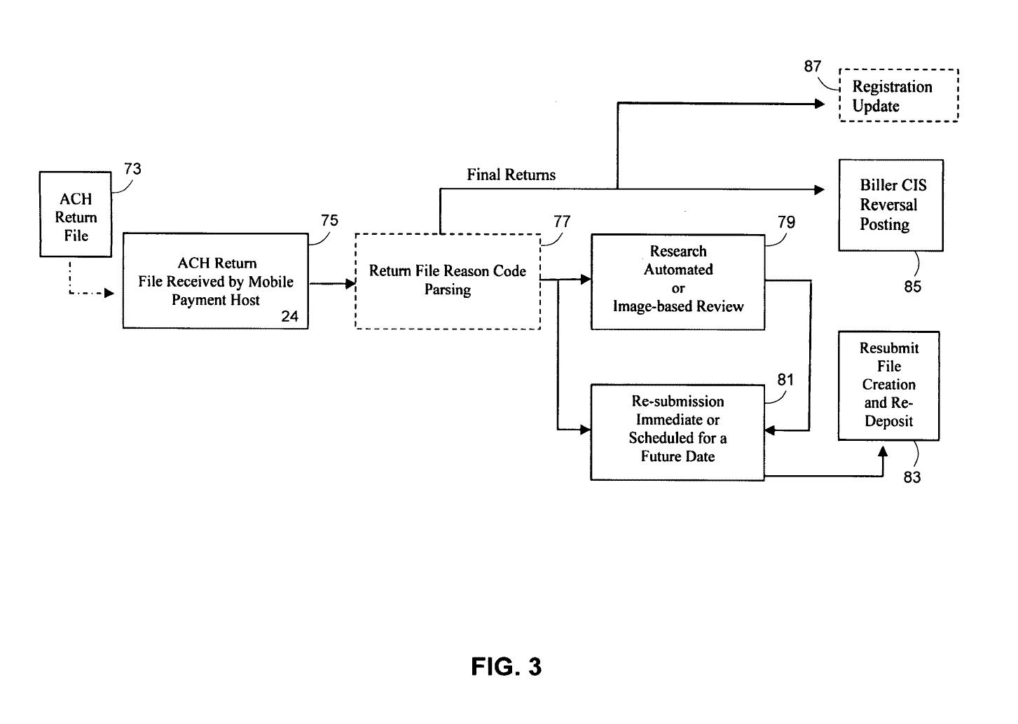

FIG. 2 is a high level operational process flow diagram of the mobile payment system 20 while FIG. 3 is a high level diagram of the mobile payment return flow of the mobile payment system 20 in accordance with the present invention. Referring first to FIG. 2, initially, as mentioned above, a consumer 26 registers for the mobile payment service with the merchant 28 by one of the methods mentioned above. The registration information provided by the consumer 26 is received by the merchant 26 and temporarily stored in a database hosted by the merchant 26 along with a unique customer ID number defining a merchant's computer information system (CIS) database, as indicated above and illustrated by the dashed box 28. The registration information is passed to the mobile message provider 22 and stored in a database along with the unique customer ID. The mobile message provider 22, in turn, may compose an SMS message and send it to the consumer 26 by way of the mobile client 32 (FIG. 1) as confirmation of the registration, as indicated by the line 52 (FIG. 2). The mobile payment system 20 may optionally be configured so that the mobile payment host 24 emulates the merchant's CIS database, as indicated by the box 54, so that the consumer merchant account information and the consumer bank account information received from the consumer 26 is accessible by the mobile payment host 24 for research and payment validation. The data from merchant's CIS database may be sent directly to the mobile payment host 24, for example by way of a wireless communication link 85. Once registration is complete, the merchant 28 provides payment data and accounts receivable data, as indicated by the boxes 56 and 58 to the mobile message provider 22. The mobile message provider 22, in turn, uses that data, to compose an SMS message 60 and send it to the mobile client 32 according to a schedule that is selectable by the merchant 28.

The consumer 26 (FIG. 1) by way of the mobile client 32 (FIG. 2) has the ability to authorize payment by return SMS message, as indicated by the box 62. The SMS message is received by the mobile message provider 22, as indicated by the box 64. The payment authorization along with the customer ID and account information is imported by the mobile payment host 24, as indicated by the box 66. The mobile payment host 24 posts the payments, as indicated by the 68.

As indicated above, the merchant may continuously post the previous day's accounts receivable (A/R) data which lists the consumer payments that cleared on the previous day, as indicated by the box 87. This A/R data may be passed to the mobile payment host 24, for example by way of the communication link 85, and form an account database 78. In this way, the risk of duplicated payments is reduced.

After the mobile payment host 24 receives the consumer payment authorization from the mobile message provider 22, the payment authorization is posted, as indicated by the box 68. Before payment is presented to the ACH 36, the mobile payment host 24 checks its account database 78, which, as mentioned above, emulates the merchant's A/R data for the previous day. The account database 78 may be hosted by the mobile payment host 24 or be located apart from the mobile payment host and accessible by way of communication links 80 and 82, as shown.

If the account database 78 indicates that a consumer payment has been previously made and cleared, the mobile payment host 24 simply posts that the requested mobile payment was previously authorized and cleared. If the account database 78 indicates that a requested payment was not yet cleared, the mobile payment host 24 presents the payment authorization to the ACH 36 for automatic clearing of the payment authorization, as indicated by the arrow 71 and creates a record of the presentment, as indicated by the box 70. The ACH 36 posts the presentment in a posting file 74, as indicated by the box 74. If the consumer authorization clears, the ACH 36 posts the deposit in a deposit file, as indicated by the box 76. The posting file 74 includes the merchant account number, routing number of the merchant's bank, the amount of the deposit, the date of the deposit and the consumer's unique ID number, as discussed above. Confirmation of each deposit in the merchant account is returned to the mobile payment host 24, as indicated by the arrow 77. The deposit confirmation may be used to update the account database 78. Once the account database 78 is updated with the deposit confirmation, the deposit confirmation from the ACH 36 is returned by the mobile payment host 24 to the merchant 28 by way of the communication links 82 and 84. Electronic payments which are not cleared by the ACH 36 are posted in a Return File which directly or indirectly includes data which identifies the merchant and consumer and the reason for the return. The Return File is electronically returned to the mobile payment host 24 and posted in a Return File, as indicated by the boxes 73 and 75. The Return File is parsed by the Mobile Payment Provider 24 to determine the return file reason code, as indicated by the box 77. Depending on the return reason code, the returns are designated for either operator assisted or automatic processing, as indicated by the boxes 79 and 81, respectively. Returns designated for automatic processing are resubmitted to the ACH 36 for clearing and deposit, as indicated by the box 83. As discussed above, certain return codes, such as return codes representative of insufficient funds in the consumer account, are automatically re-presented to the ACH 36. Operated assisted return processing normally requires manual processing, as discussed above. Returns that cannot be cleared are posted as final returns and reverse posted, as indicated by the box 85. The return is also noted in the consumer's registration file, as indicated by the box 87.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A mobile payment system comprising:
a mobile message provider configured to send and receive messages from other electronic devices including a mobile client by way of a wireless communication network for receiving registration information and payment authorizations from clients and a merchant computer information system (CIS) which stores merchant data and consumer data, said merchant data including said merchant's bank account number and bank routing number, said consumer data including said consumer's bank account number and bank routing number; and
a mobile payment host in electronic communication with said mobile message provider for receiving said merchant and consumer data as well as said payment authorization from said mobile client, said mobile payment host configured to be in electronic communication with an automated clearing house and further configured upon receipt of said payment authorizations to electronically present said merchant data and said consumer data to the automated clearing house for deposit into a merchant's bank account and post said deposits or alternatively process returns from said automated clearing house for payment authorizations that cannot be processed.

2. The mobile payment system as recited in claim 1, wherein said mobile payment host is configured to analyze and automatically process at least a portion of said returns from said automated clearing house.

3. The mobile payment system as recited in claim 2, wherein said mobile payment host is configured to parse return codes from said automated clearing house in order to determine the reason for the return.

4. The mobile payment system as recited in claim 2, wherein said mobile payment host is configured to re-present payment authorizations based upon at least one predetermined return code.

5. The mobile payment system as recited in claim 4, wherein said re-presentment is done immediately.

6. The mobile payment system as recited in claim 4, wherein said re-presentment is scheduled for a future date.

7. The mobile payment system as recited in claim 3, wherein said mobile payment host reverse posts said payment authorization 3 in response to predetermined return codes.

8. The mobile payment system as recited in claim 3, wherein said mobile payment host said registration information in response to predetermined return codes.

9. The mobile payment system as recited in claim 1, wherein said mobile payment host emulates said merchant CIS.

10. A method for processing mobile payments, the method comprising the steps of:
(a) receiving payment authorizations from mobile clients for making payments on consumer accounts with selected merchants, said payment authorizations received by way of a wireless communication link;
(b) receiving and storing merchant bank account and bank routing numbers defining merchant data;
(c) receiving and storing consumer bank account and bank routing numbers defining consumer data;
(b) upon receipt of said payment authorizations, automatically presenting said merchant data and said consumer to an automated clearing house for clearing and deposit in a merchant account; and
(c) automatically posting said deposit in a deposit file.

11. The method as recited in claim 10, further including step (d).
(d) processing return codes from said automated clearing house when payments cannot be cleared by said automated clearing house.

12. The method as recited in claim 11 wherein step (d) comprises:
(d) parsing return codes from said automated clearing house and automatically analyzing and classifying said return.

13. The method as recited in claim 12 wherein step (d) comprises:
(d) parsing returns codes from said automated clearing house and automatically analyzing and classifying said return for either manual or automatic processing.

14. The method as recited in claim 13 wherein step (d) comprises:
(d) parsing returns codes from said automated clearing house and automatically analyzing and classifying said return for either manual or automatic processing for re-presentment to said automated clearing house.

15. The method as recited in claim 14 wherein step (d) comprises:
(d) parsing returns codes from said automated clearing house and automatically analyzing and classifying said return for either manual or automatic processing for re-presentment to said automated clearing house immediately.

16. The method as recited in claim 14 wherein step (d) comprises:
(d) parsing returns codes from said automated clearing house and automatically analyzing and classifying said return for either manual or automatic processing for re-presentment to said automated clearing house at a future date.
